(19) United States
(12) Patent Application Publication
(10) Pub. No.: US 2016/0261789 A1
(43) Pub. Date: Sep. 8, 2016

(54) METHOD FOR INDEPENDENTLY DETERMINING EXPOSURE AND FOCUS SETTINGS OF A DIGITAL CAMERA

(71) Applicant: Sony Corporation, Tokyo (JP)

(72) Inventor: Sanbao XU, Lund (SE)

(21) Appl. No.: 14/640,875

(22) Filed: Mar. 6, 2015

(51) Int. Cl. H04N 5/232; G06F 3/0486; G06F 3/0488; G06F 3/0481

(52) U.S. Cl. CPC H04N 5/23216; H04N 5/23293; G06F 3/04817; G06F 3/0486; G06F 3/0488; G06F 2203/04808

(57) ABSTRACT

The present invention relates to a method for independently determining exposure and focus settings of a digital camera having a touch screen (15). The method comprising: detecting a first touch on the touch screen for setting a metering area (30) of a first view of the digital camera; determining an exposure setting by measuring light conditions within the metering area; detecting a second touch on the touch screen for setting a focusing area (35) of a second view of the digital camera; and determining a focus setting for an object within the focusing area.

### TECHNICAL FIELD

The present invention relates to a method for determining exposure and focus settings of a digital camera having a touch screen.

### BACKGROUND

Metering and focusing are two of the most important operations upon taking a picture with a digital camera.

Conventionally, there are a number of metering methods, such as Evaluative, Centre-weighted Average, Partial and Spot. These methods use an area in the current field of view to measure the brightness of the scene. The measured metered value in turn determines the exposure, i.e. which lens aperture will be used for the picture to be taken. Electronic devices dedicated as a digital camera, e.g. a digital single-lens reflex, DSLR, camera, may comprise a lock button with which the user can lock a measured metering value. Using this button, experienced users or photographers may adopt clever tricks to fool the camera to achieve some special picture effect as opposed to a normal exposure. Conventionally, the metering area is chosen from a group of predetermined areas within the viewfinder of the digital camera by turning a wheel button of the digital camera.

Conventionally, there are a number of focusing modes to choose from, such as Continuous focusing, One shot focusing, Automatic focusing, and Manual focusing on a digital camera. These methods use an area in the current field of view to measure a focusing value of the scene. The measured focusing value in turn determines the focusing setting that will be used for the picture to be taken. Conventionally, the focusing area is chosen from a group of predetermined areas within the viewfinder of the digital camera by turning a wheel button of the digital camera.

Hence, on electronic devices dedicated as a digital camera comprising the lock button for locking a measured metering value, the metering and focusing operations may be performed independently from each other. This implies that the metering and focusing areas may be chosen independently from each other. For example, the user may point the digital camera towards one view comprising an area having brightness levels suitable for measuring the metering value in order for determining the exposure of the digital camera and towards another view comprising the object of interest to be in focus for the picture to be taken.

On electronic devices not being only dedicated as a digital camera there is normally no lock button for locking a measured metering value. For such electronic devices/digital cameras the same area is used for measuring both the metering value and the focusing value. Electronic devices/digital cameras not being only dedicated as a digital camera may e.g. be: a compact digital camera, a smart phone, a PDA, a tablet or a laptop computer having a touch screen arranged to display the current field of view for the digital camera. Conventionally, the user can freely choose the focusing area by tapping the point of interest on the touch screen. Conventionally, the metering area is the same as the focusing area. Hence, the metering and focusing areas may not be chosen independently from each other.

There are some shortcomings having the metering area at the same place as the focusing area. In practice it is often that the brightness in focusing area (also used as metering area) is not what is wanted for measuring the metering value. Sometimes it is difficult or even impossible to achieve a stable focusing at/inside a desired metering area (also used as focusing area), for example, the metering area is pointed to the sky (or a strong light source). Moreover, for experienced users it is highly desirable to be able to freely choose the metering area and the focusing area independently.

### SUMMARY OF THE INVENTION

In view of the above, it is an object of the present invention to provide an alternative method for choosing the metering area and the focusing area independently from each other.

According to a first aspect a method for determining exposure and focus settings of a digital camera having a touch screen is provided. The method comprises detecting a first touch on the touch screen for setting a metering area of a first view of the digital camera; determining an exposure setting by measuring light conditions within the metering area; detecting a second touch on the touch screen for setting a focusing area of a second view of the digital camera; and determining a focus setting for an object within the focusing area.

Accordingly, the metering and focusing areas used for determine exposure and focus settings of a digital camera may be selected completely independently from each other. The problems mentioned above are now easily solved because we separate the metering area from the focusing area and choose them independently. Hence, the determining of exposure and focus settings of the digital camera may be made in an intuitive and efficient way.

The metering area and/or focusing area may be of a predetermined size. The first and/or second touch may determine the position of the area of a predetermined size.

The metering area and/or the focusing area may be represented by graphical objects on the touch screen.

The metering area and the focusing area may be represented by graphical objects simultaneously displayed on the touch screen.

The metering area and the focusing area may be represented by graphical objects not simultaneously displayed on the touch screen.

The first or second touch may be a touch gesture defining the metering area or the focusing area. The first or second touch may be a touch gesture encircling the metering area or the focusing area.

The first and second touches may be different touch gestures setting the metering area and the focusing area.

The first and second views may be the same view.

The first and second views may be different views.

The first touch may correspond to a start point of a touch gesture and the second touch corresponds to an end point of the same touch gesture.

The first touch may be a drag and drop touch for placing a first predetermined graphical object at a desired position on the touch screen. The second touch may be a drag and drop touch for placing a second predetermined graphical object at a desired position on the touch screen.

The metering area and the focusing area may not fully overlap.

According to a second aspect a digital camera is provided. The digital camera comprising a processor; and a memory, coupled to the processor, which memory stores instructions arranged to cause the processor to perform the above method.

According to a third aspect a non-transitory computer-readable recording medium is provided. The non-transitory computer-readable recording medium having recorded thereon a program for implementing the above method when executed on a device having processing capabilities.

The above mentioned features of the method for determining exposure and focus settings of a digital camera having a touch screen, when applicable, apply to the second and third aspects as well. In order to avoid undue repetition, reference is made to the above.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description.

Hence, it is to be understood that this invention is not limited to the particular component parts of the device described or steps of the methods described as such device and method may vary. It is also to be understood that the terminology used herein is for purpose of describing particular embodiments only, and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above and other aspects of the present invention will now be described in more detail, with reference to appended drawings showing embodiments of the invention. The figures should not be considered limiting the invention to the specific embodiment; instead they are used for explaining and understanding the invention.

As illustrated in the figures, the sizes of layers and regions are exaggerated for illustrative purposes and, thus, are provided to illustrate the general structures of embodiments of the present invention. Like reference numerals refer to like elements throughout.

FIG. 1 illustrates a digital camera.

FIG. 2 is a block scheme of a method for determining exposure and focus settings of the digital camera of FIG. 1.

FIGS. 3a and 3b illustrates the selection of metering and focusing areas used for determining exposure and focus settings of the digital camera of FIG. 1.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and to fully convey the scope of the invention to the skilled person.

As will be appreciated by one skilled in the art, aspects of the present invention may be embodied as a device, method or computer program product. Accordingly, aspects of the present invention may take the form of an entirely hardware embodiment, an entirely software embodiment (including firmware, resident software, micro-code, etc.) or an embodiment combining software and hardware. Furthermore, the present invention may take the form of a computer program product embodied in one or more computer readable medium(s) having computer readable program code embodied thereon.

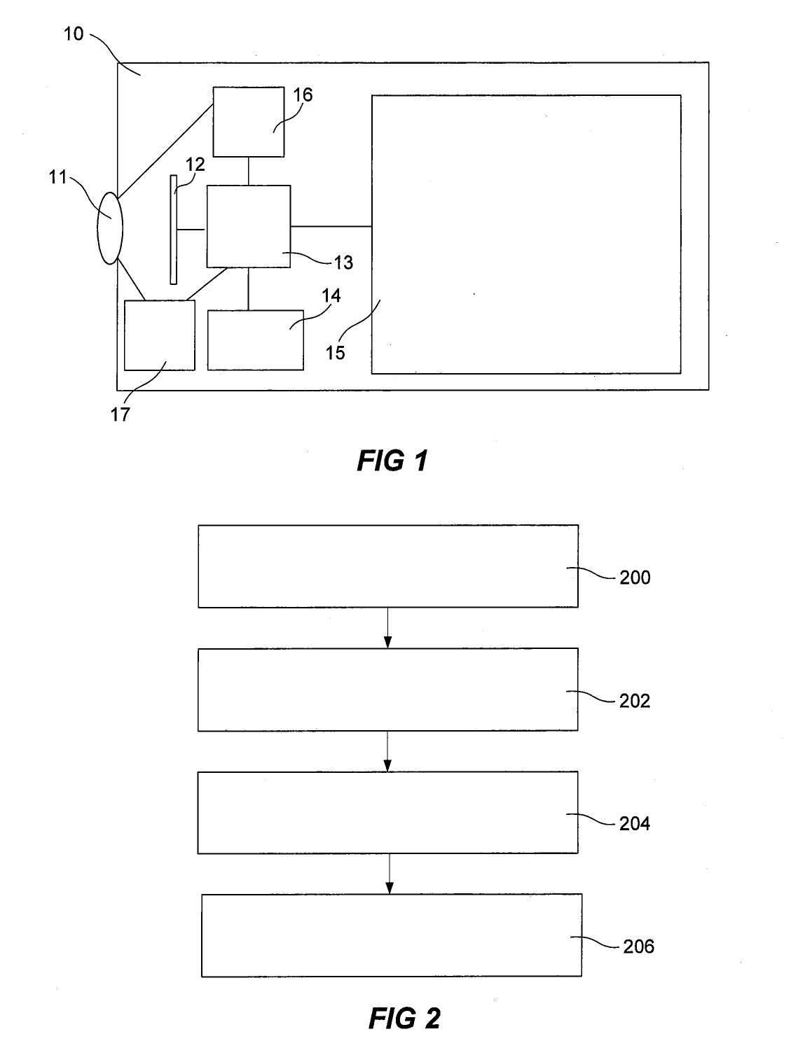

FIG. 1 illustrates a digital camera 10 comprising a lens unit 11, an image sensor unit 12, a processor 13, a memory 14, a touch screen 15, an exposure controller 16 and a focus controller 17. The digital camera 10 may be implemented in a portable electronic device. The digital camera 10 may be implemented in a compact digital camera, a digital single-lens reflex, DSLR, camera, a mobile phone, a PDA, a tablet or a laptop computer. The digital camera 10 may have various form factors.

The digital camera 10 is arranged to capture images of a view towards which the digital camera is directed. The lens unit 11 is arranged to focus light originating from the view onto the image sensor unit 12. Hence, the digital camera 10 is arranged to capture an image through the lens unit 11 and the image is then projected onto the image sensor unit 12. The image sensor unit 12 may be a CMOS-based sensor or a CCD sensor, although other types of sensors are possible.

The processor 13 is arranged to perform a variety of acts or processes. The processor may arranged to perform one of more of the following acts converting a signal from the image sensor unit 12 into a digital image, compressing a digital image, decompressing a digital image or performing any of the acts of the present invention. The processor 13 may comprise a single processing unit or multiple processing units. In case of multiple processing units each processing unit may be specialized in performing one or more acts of processing.

The memory 14 is arranged to buffer and or store data being processed by the processor 13. The memory 14 may comprise a single memory or a plurality of different memories. In case of a plurality of memories each memory may be specialized in storing one or more kind of data.

The touch screen 15 is arranged to register a touch of e.g. a stylus or a user's finger or fingers. The touch may be registered as a single touch giving the coordinates of the touch on the touch screen. Alternatively, or in combination, the touch may be a touch gesture, e.g. an encircling gesture defining an area on the touch screen, a sliding gesture, a pinching gesture, a spread gesture, a drag and drop gesture, etc. Various implementations for a touch screen are known to the person skilled in the art and will not be discussed. The touch screen may also be arranged to display a preview of a view being “seen” by the digital camera. The touch screen may also be arranged to display graphical objects indicating areas of the current view of the digital camera. The areas may e.g. represent a metering area or a focusing area.

The exposure controller 16 is arranged to control a shutter of the lens unit 11 in order to control the exposure of a digital image to be captured by the digital camera. The exposure controller 16 is arranged to control the shutter based on information gathered during a metering operation for the digital camera as discussed above and as will be further discussed below.

The focus controller 17 is arranged to control one or more optical elements of the lens unit 11 in order to control the focus of a digital image to be captured by the digital camera. The focus controller 17 is arranged to control the optical elements of the lens unit 11 based on information gathered during a focusing operation for the digital camera as discussed above and as will be further discussed below.

In connection with FIG. 2 a method for determining exposure and focus settings of the digital camera 10 having the touch screen 15 will be discussed. The method comprising the acts of: detecting, act 200, a first touch on the touch screen 15 for setting a metering area of a first view of the digital camera 10; determining, act 202, an exposure setting by measuring light conditions within the metering area; detecting, act 204, a second touch on the touch screen for setting a focusing area of a second view of the digital camera 10; and determining, act 206, a focus setting for an object within the focusing area.

The first and second views may be the same view. Alternatively, the first and second views may be different views.

The metering area and the focusing area do not fully overlap.

The metering area and/or focusing area may be of a predetermined size. The first and/or second touch may be arranged to determine the position of the area of the predetermined size. The metering area and/or the focusing area may be represented by graphical objects on the touch screen. The metering area and the focusing area may be represented by graphical objects simultaneously displayed on the touch screen. Alternatively, the metering area and the focusing area may be represented by graphical objects not simultaneously displayed on the touch screen. The first or second touch may be a touch gesture defining the metering area and/or the focusing area. The first or second touch may define the metering area and/or the focusing area by a touch gesture encircling the respective area. Alternatively, or in combination, the first and second touches may be different touch gestures setting the metering area and the focusing area. Alternatively, the first touch may correspond to a start point of a touch gesture and the second touch may correspond to an end point of the same touch gesture. Alternatively, the first touch may be a drag and drop touch for placing a first predetermined graphical object at a desired position on the touch screen, and the second touch may a drag and drop touch for placing a second predetermined graphical object at a desired position on the touch screen.

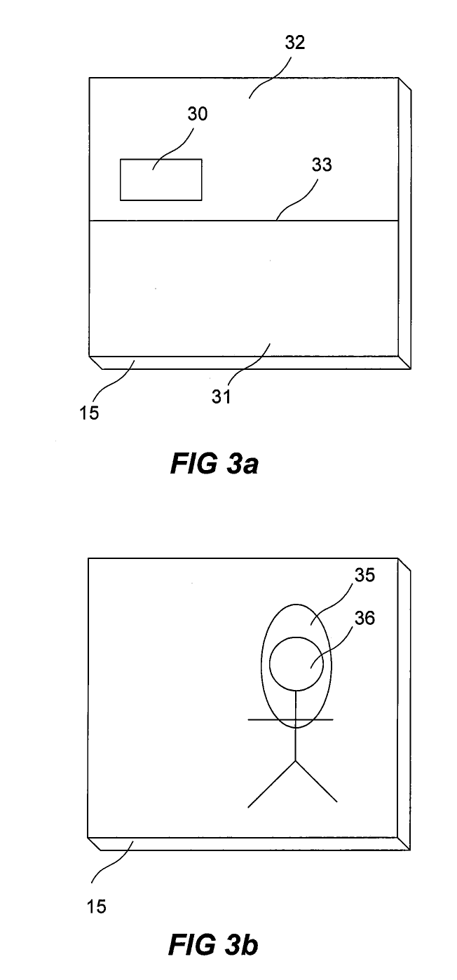

Hence, a method to independently select the metering area and the focusing area is provided. Below in connection with FIGS. 3a and 3b alternative embodiments for carrying out this in a preview picture displayed on the touch screen 15 are presented.

Since most people are accustomed to the picture-taking habit of doing the focus at the last step before pressing capturing a picture/image the metering area is selected first and the focusing area after that.

The metering area 30 is selected by arranging a first frame on the touch screen 15 in a preview image displayed on the touch screen, see FIG. 3a. In FIG. 3a the preview image is an image of a field 31 and a sky 32 separated by a horizon 33. The first frame is having a predetermined geometrical shape. In FIG. 3a the first frame is having the geometrical shape of a rectangle. However, the frame may have any kind of predetermined geometrical shape. The frame may e.g. be shaped as a rectangle, a quadrate a circle or any other suitable predetermined geometrical shape. In the shown embodiment in FIG. 3a the location of the first frame is selected by a first touch on the touch screen 15. The first touch on the touch screen 15 may e.g. be preceded by a displaying of a first hint message. The first hint message may e.g. be saying “please selected a location for the metering area”. Alternatively, or in combination the first touch on the touch screen for selecting the location of the first frame may be a move of an already displayed first frame by a touch gesture. This touch gesture may e.g. be a drag and drop gesture. After the selection of the metering area 30, i.e. selection of the location of the first frame, a metering measurement is performed. Note that, the user may freely point the digital camera to other places than the scene to be depictured by an image to be captured. For example in FIG. 3a the digital camera is directed towards a scene comprising the field 31, the sky 32 and the horizon 33 and the metering area 30 is selected to be located in a part of the sky 32.

The focusing area 35 is selected by arranging a second frame on the touch screen 15 in a preview image displayed on the touch screen, see FIG. 3b. In FIG. 3b the preview image is an image of a person 36. Hence, the preview image in which the focusing area is selected may be different from preview image in which the metering area is selected. The second frame is having a predetermined geometrical shape. In FIG. 3b the second frame is having the geometrical shape of an ellipse. However, the frame may have any kind of predetermined geometrical shape. The frame may e.g. be shaped as a rectangle, a quadrate a circle or any other suitable predetermined geometrical shape. In the shown embodiment in FIG. 3b the location of the second frame is selected by a second touch on the touch screen 15. The second touch on the touch screen 15 may e.g. be preceded by a displaying of a second hint message. The second hint message may e.g. be saying “please selected a location for the focusing area”. Alternatively, or in combination the second touch on the touch screen for selecting the location of the second frame may be a move of an already displayed second frame by a touch gesture. This touch gesture may e.g. be a drag and drop gesture. After the selection of the focusing area 35, i.e. selection of the location of the second frame, a focusing measurement is performed. Note that the user at this point needs to point the digital camera to the scene comprising the object she intends to take an image of. In this case pointing the digital camera towards the person 36. When the focusing measurement is performed, the digital camera performs the focusing and the image is captured.

According to the above, the metering area is selected before selecting the focusing area. It is however realized that it may very well be the other way around, first selecting the focusing area and thereafter selecting the metering area.

According to one embodiment the first and second frames may be displayed simultaneously on the touch screen. Although, displaying the first and second frames simultaneously the selection of the metering and focusing areas are still made sequentially. According to this embodiment moving of the first and second frames may be registered as touch gestures on the touch screen. Hence, the first and second frames may be dragged or dropped such that the focusing and metering areas are selected. Also for this embodiment the digital camera may be freely oriented when selecting the metering area but when selecting the focusing area the digital camera needs to be pointed towards the intended scene.

The first and second frames may have different predetermined geometrical shapes.

The first and second frames may have the same predetermined geometrical shape.

Alternatively or in combination, the first and second frames may be of different colors.

For the various embodiments presented, in connection with selecting the metering area the size of the metering area may be altered. This may be made by a touch gesture on the touch screen.

For the various embodiments presented, in connection with selecting the focusing area the size of the focusing area may be altered. This may be made by a touch gesture on the touch screen.

Upon selecting the metering area only the metering value is measured. Upon selecting the focusing area only the focusing value is measured.

The person skilled in the art realizes that the present invention by no means is limited to the preferred embodiments described above. On the contrary, many modifications and variations are possible within the scope of the appended claims.

For example, the metering and/or focusing area may be selected by a drawing touch gesture outlining the selected area. This will form a contiguous metering and/or focusing area that approximates the one drawn by the touch gesture on the touch screen.

The metering and focusing areas may be selected by registering a slide gesture on the touch screen. At the start point of the slide gesture the metering area is selected and the end point of the slide gesture the focusing area is selected (or vice verse).

Moreover, for simple/quick picture taking, the original option that the metering area and the focusing area coincide should still be kept as the default option.

Furthermore, the proposed method or methods may be selectable as an advanced option in the settings of the digital camera.

Additionally, variations to the disclosed embodiments can be understood and effected by the skilled person in practicing the claimed invention, from a study of the drawings, the disclosure, and the appended claims.

1. A method for independently determining exposure and focus settings of a digital camera having a touch screen; the method comprising the acts of:
detecting a first touch on the touch screen for setting a metering area of a first view of the digital camera;
determining an exposure setting by measuring light conditions within the metering area;
detecting a second touch on the touch screen for setting a focusing area of a second view of the digital camera;
determining a focus setting for an object within the focusing area.

2. The method according to claim 1, wherein the metering area and/or focusing area is of a predetermined size.

3. The method according to claim 2, wherein the first and/or second touch determines the position of the area of a predetermined size.

4. The method according to claim 1, wherein the metering area and/or the focusing area are represented by graphical objects on the touch screen.

5. The method according to claim 4, wherein the metering area and the focusing area are represented by graphical objects simultaneously displayed on the touch screen.

6. The method according to claim 4, wherein the metering area and the focusing area are represented by graphical objects not simultaneously displayed on the touch screen.

7. The method according to claim 1, wherein the first or second touch is a touch gesture defining (encircling) the metering area or the focusing area.

8. The method according to claim 1, wherein the first and second touches are different touch gestures setting the metering area and the focusing area.

9. The method according to claim 1, wherein the first and second views are the same view.

10. The method according to claim 1, wherein first and second views are different views.

11. The method according to claim 1, wherein the first touch corresponds to a start point of a touch gesture and the second touch corresponds to an end point of the same touch gesture.

12. The method according to claim 1, wherein the first touch is a drag and drop touch for placing a first predetermined graphical object at a desired position on the touch screen, and wherein the second touch is a drag and drop touch for placing a second predetermined graphical object at a desired position on the touch screen.

13. The method according to claim 1, wherein the metering area and the focusing area does not fully overlap.

14. A digital camera comprising:
a processor; and
a memory, coupled to the processor, which stores instructions arranged to cause the processor to perform the method of claim 1.

15. A non-transitory computer-readable recording medium having recorded thereon a program for implementing the method according to claim 1 when executed on a device having processing capabilities.
